(19) United States
(12) Patent Application Publication
(10) Pub. No.: US 2013/0006762 A1
(43) Pub. Date: Jan. 3, 2013

(54) SYSTEM AND METHOD FOR COLLECTION AND DISPLAY OF TIME SENSITIVE INFORMATION

(75) Inventors: Robert Y. Greenberg, Portland, OR (US); Michael G. West, Portland, OR (US)

(73) Assignee: TABLESUP, INC., Portland, OR (US)

(21) Appl. No.: 13/536,958

(22) Filed: Jun. 28, 2012

Related U.S. Application Data
(60) Provisional application No. 61/502,859, filed on Jun. 30, 2011.

(51) Int. Cl. G06Q 30/02

(52) U.S. Cl. 705/14.49

(57) ABSTRACT

A system and method for collecting and displaying time sensitive information consisting of multiple information sources connected to an information storage facility via an upload link. The information storage facility may, in turn, be interrogated by information sinks via a download link to display the collected time sensitive information. The system may support multiple alternate information storage facilities by allowing them to connect to the information storage facility via an API. The multiple alternate information storage facilities may communicate with information sinks via an alternate download link.

### RELATED APPLICATIONS

The present claims priority to provisional patent application Ser. No. 61/502,859, filed Jun. 30, 2011 and titled “System And Method For Collection And Display Of Time Sensitive Information.”

### COPYRIGHT NOTICE

© 2012 TablesUp, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all rights available under 37 CFR §1.71(d).

### TECHNICAL FIELD

We disclose a system and method for collecting, storing, and disseminating time sensitive information.

### BACKGROUND

Typical systems for collecting, storing, and disseminating time sensitive information involve direct communication between the information source and the information sink. As the name implies, the information source is any producer or generator of information. Likewise, an information sink is a receiver of the information produced or generated by the information source.

Alternatively, there are systems that allow information sources to store time sensitive information at an intermediate location so that information sinks may access that information from the intermediate location. In both of cases, the information sink must access each information source sequentially. This approach is time consuming and differences in the manner in which the information is provided by the information sources makes interpreting the time sensitive information difficult. Additionally, collecting time sensitive information from information sources may be a time consuming, manual process.

The technology to address the collection, storage, and dissemination of time sensitive information is continuously developing and improving, but challenges still exist including challenges involving collecting, storing, and disseminating.

### BRIEF DRAWINGS DESCRIPTION

FIG. 1 is a block diagram of an embodiment of a system of the present invention.

FIG. 2A is a block diagram of an embodiment of the present invention.

FIG. 2B is a diagram of an embodiment of the present invention.

FIG. 3 is a diagram of an embodiment of an interface for an information source.

FIG. 4 is a diagram of an embodiment of an interface for an information source.

FIG. 5 is a diagram of an embodiment of an interface for an information sink.

FIG. 6 is a diagram of an embodiment of an interface for an information sink.

### DETAILED DESCRIPTION

We describe some portions of embodiments of systems and associated methods using algorithms and symbolic representations of operations on data bits within a memory, e.g., memory included in Information Storage 100 or Alternate Info Storage 102. A person of skill in the art will understand these algorithms and symbolic representations as most effectively conveying the substance of their work to others of skill in the art. An algorithm is a self-consistent sequence leading to a desired result. The sequence requires physical manipulations of physical quantities. Usually, but not necessarily, these quantities take the form of electrical or magnetic signals capable of being stored, transferred, combined, compared, and otherwise manipulated. For expressively simplicity, we refer to these signals as bits, values, elements, symbols, characters, terms, numbers, or like. The terms are merely convenient labels. A person of skill in the art will recognize that terms such as computing, calculating, determining, displaying, or like refer to the actions and processes of computers and computing devices. The computers or computing devices manipulate and transform data represented as physical electronic quantities within the memory into other data similarly represented as physical electronic quantities within the memory. The algorithms and symbolic representations we describe above may result in data, files, records, or the like that are stored in one or more databases.

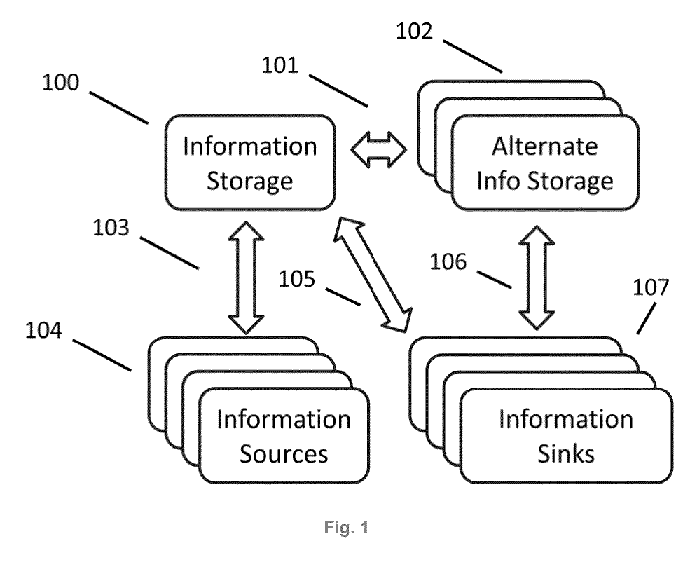

FIG. 1 is a block diagram of an embodiment of a system of the present invention. Referring to FIG. 1, Information Storage 100 may be communicatively coupled to Alternate Info Storage 102, Information Sources 104, and Information Sinks 107. Although FIG. 1 shows a plurality of Alternate Info Storage 102, Information Sources 104, and Information Sinks 107, a person of ordinary skill in the art should recognize that any number is possible. Information Storage 100 and Alternate Info Storage may be coupled through Application Programming Interface (API) 101. Information Storage 100 and Information Sources 104 may be coupled through Upload Link 103. Information Storage 100 and Information Sinks 107 may be coupled through Download Link 105. Alternate Info Storage 102 and Information Sinks 107 may be coupled through Alternate Download Link 106.

Information Sources 104 may, from time to time, send new information to the Information Storage 100 via the Upload Link 103. This new information may be sent on an as-needed basis as determined by Information Sources 104 or in response to a request for the information from Information Sinks 107. It may also be sent on a periodic basis as determined by Information Sources 104 or Information Storage 100.

As it collects information, Information Storage 100 may modify, sort, and otherwise prepare the new information for eventual retrieval by Information Sinks 107 or Alternate Info Storage 102. For example, Information Storage 100 may store the information, a time of collection, and an identification of the source of the information in one or more locations in a database. Information Storage 100 may store the information in a logfile used to generate statistics. Information Storage 100 may store the information in a format that allows for quick access or download to a computing device. Or Information Storage 100 may store the information in a manner that allows access only to authorized users, e.g., Syndication Partner 202.

Information Sinks 107 may request information from Information Storage 100 via the Download Link 105. Alternately, Information Storage 100 may notify Information Sinks 107 when new information is available via Download Link 105 for retrieval of information on an as-needed or periodic basis. When Information Sinks 107 request information from Information Storage 100, it may provide filtering criteria so that Information Storage 100 limits the information provided to Information Sinks 107 based on that filtering criteria. A person of ordinary skill in the art should recognize that the filtering criteria may include well known query types of filters, including filters by date, area, wait time, distance, and the like.

Information Sinks 107 may further process the information retrieved via Download Link 105 before that information is made available, e.g., to a user or a computing device. After Information Sinks 107 downloads data, it may format, sort, filter or the like before the information is made available, e.g., to a user or a computing device. For example, the Information Sinks 107 may display the information using predetermined rules, e.g., a predetermined color scheme by wait times as we explain in more detail below. For another example, the Information Sinks 107 may display the information in a variety of tabular or graphical formats.

Information stored in Information Storage 100 may also be sent to Alternate Info Storage 102 via API 101, on an as-needed or periodic basis as determined by Information Storage 100 or Alternate Info Storage 102.

Once the information is received by Alternate Info Storage 102, it may be further processed by the Alternate Info Storage 102.

Information Sinks 107 may request information from Alternate Info Storage 102 via the Alternate Download Link 106. Alternate Info Storage 102 may notify Information Sinks 107 when new information is available via Alternate Download Link 106. This retrieval of information may occur on an as-needed or periodic basis.

Information Sinks 107 may further process the information retrieved via Alternate Download Link 106 before that information is made available, e.g., to a user or a computing device. Information Sinks 107 used with Alternate Info Storage 102 may be different from Information Sinks 107 used with Information Storage 100.

A person of ordinary skill in the art will recognize that Information Storage 100 should be of sufficient capacity and speed to handle the aggregate requirements of Information Sources 104, Information Sinks 107, and Alternate Info Storage 102. A person of ordinary skill in the art will recognize that communication links such as Upload Link 103, Download Link 105, API 101, and Alternate Download Link 106 should have sufficient capacity to handle the maximum information traffic anticipated by the links.

Information Storage 100 and Alternate Info Storage 102 may not be directly accessible to most users of the system. Information Storage 100 and Alternate Info Storage 102 may be indirectly accessible through Information Sources 104 and Information Sinks 107.

A person of ordinary skill in the art should recognize that Information Storage 100 and Alternate Info Storage 102 may include any number or type of computing devices, situated locally or remotely, operating alone or in groups. Information Storage 100 and Alternate Info Storage 102 may include a personal computer or group of personal computers, a computer server or groups of computer servers, or the like. The computing devices may be local or situated at a remote hosting site. The computing devices may be virtual servers rented from a “cloud” server provider. The computing devices may include memory devices or computer readable medium configured to store data or instructions that implement some or all of the functions of Information Storage 100 or Alternate Info Storage 102.

Information Sources 104 and Information Sinks 107 may include any number or type of computing devices, situated locally or remotely, operating alone or in groups. Information Sources 104 and Information Sinks 107 may include a personal computer or group of personal computers, a computer server or groups of computer servers, or the like. The computing devices may be local or situated at a remote hosting site. The computing devices may be virtual servers rented from a “cloud” server provider. The computing devices may include any number of memory devices or computer readable medium configured to store data or instructions that implement some or all of the functions of Information Sources 104 and Information Sinks 107. Information Sources 104 and Information Sinks 107 may be any number or type of fixed or mobile computing devices including personal computers, tablet computers, fixed phones, or mobile phones.

A person of ordinary skill in the art should recognize that Upload Link 103, Download Link 105, and Alternate Download Link 106 may use any type of electronic communication methods including Transmission Control Protocol/Internet Protocol (TCP/IP), User Datagram Protocol (UDP), email, Short Message Service (SMS), touch-tone phone, voice messages, or the like.

A person of ordinary skill in the art should recognize that API 101 may use any type of electronic communication methods including TCP/IP, UDP, File Transfer Protocol (FTP), database queries, server-to-server communications, or the like.

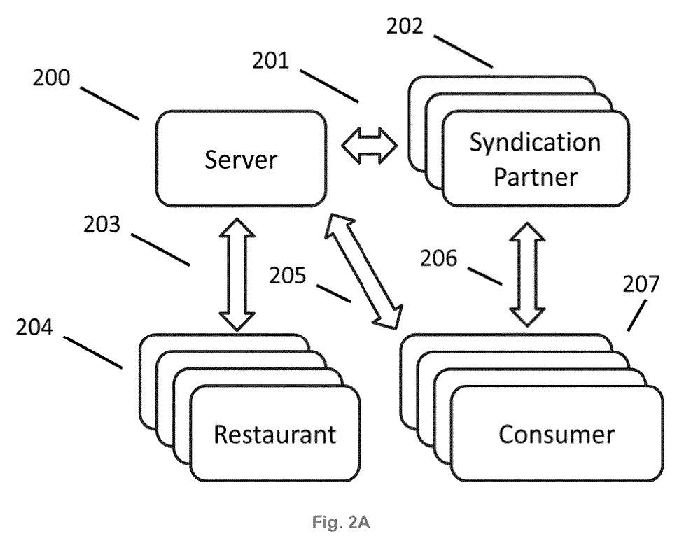

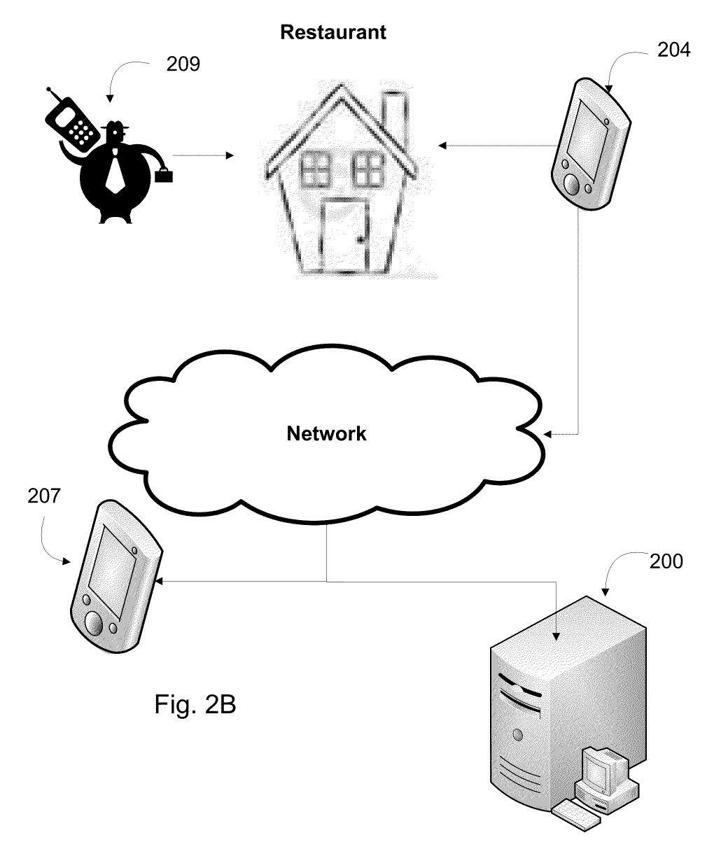

Referring FIGS. 2A-6 describe a system and method for collecting and distributing time sensitive information from a restaurant to a consumer through a server. In the system and method shown in FIGS. 2A-6, a restaurant would operate a component Restaurant 204 on a computing device, while a consumer would operate a component Consumer 207 on a computing device. These components are often sets of instructions stored in a memory device or computer readable medium that, when executed by a processing device, causes the processing device to perform a set of particular actions. The computer readable medium or the processing device may be included in any number or type of fixed or mobile computing devices including personal computers, tablet computers, fixed phones, or mobile phones.

Restaurant 204, Consumer 207, Server 200, and Syndication Partner 202 are referred herein in the singular for simplicity only. A person of ordinary skill in the art should recognize that more than a single Restaurant 204, Consumer 207, Server 200, or Syndication Partner 202 are possible and come within the scope of the present disclosure.

Server 200 may be coupled to Syndication Partner 202 through API 201. Server 200 may be coupled to Restaurant 204 through Upload Link 203. Server 200 may be coupled to Consumer 207 through Download Link 205. Syndication Partner 202 may be coupled to Consumer 207 through Alternate Download Link 206.

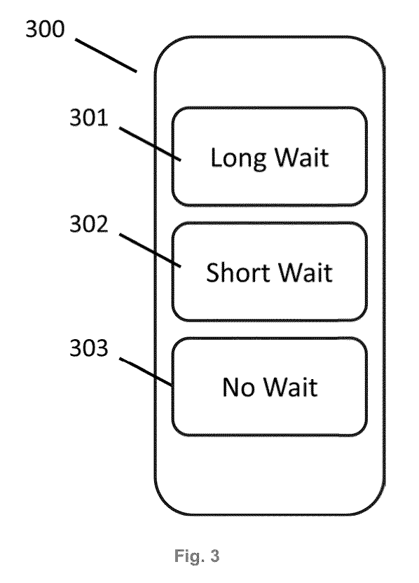

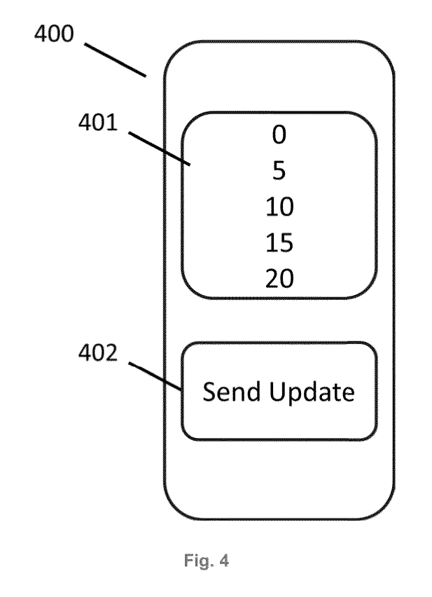

Restaurant 204 may be implemented as an application running on any type of computing device and available to one or more users, e.g., a restaurant owner, employee, or manager. FIGS. 3 and 4 show alternate embodiments of such an application for Restaurant 204. First Restaurant Application 300 includes Long Wait 301, Short Wait 302, and No Wait 303 buttons, which may be virtual or otherwise. Second Restaurant Application 400 includes Time Selector 401 and Send Update 402 buttons, also virtual or otherwise. Restaurant 204 may be implemented as an application in which one or more users may be able to input time sensitive information, e.g., wait times, associated with a merchant or commercial establishment, e.g., restaurant. Such time sensitive information may be specific, e.g., 45 minutes, or non-specific, e.g., more than 30 minutes. Restaurant 204 may support or implement any manner of mechanisms, virtual or otherwise, known to a person of ordinary skill in the art to allow the one or more users to input the time sensitive information.

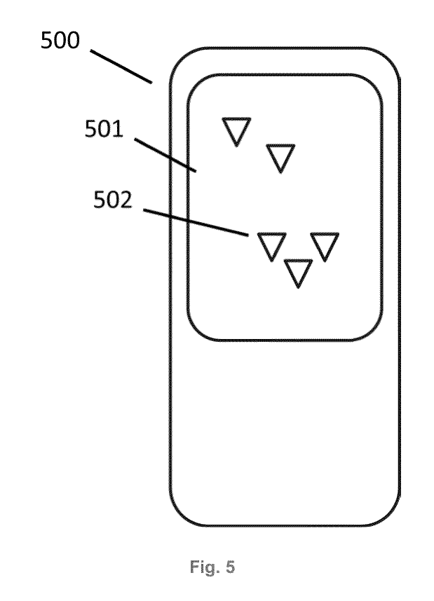

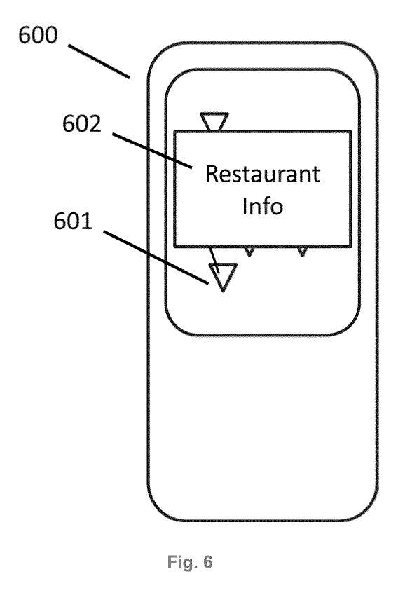

Consumer 207 may be implemented as an application running on any type of computing device and available to one or more users, e.g., a consumer of restaurant services. FIGS. 5 and 6 show alternate embodiments of such an application for Consumer 207. First Consumer Application 500 includes Map Area 501 and Map Pins 502. Second Consumer Application 600 includes Selected Map Pin 601 and Restaurant Info Display 602.

Still referring to FIGS. 2-6, Restaurant 204 may, from time to time, send new information to Server 200 via Upload Link 203. Restaurant 204 may send this new information on an as needed or periodic basis as determined by Restaurant 204 or Server 200. Restaurant 204 may include the ability for the user to program the frequency in which it prompts or reminds a user to send the new information or Restaurant 204 may include pre-programmed or default settings for this purpose. Restaurant 204 may send the new information in response to manual input from one or more users. Restaurant 204 may include a reminder function that periodically prompts or reminds a user to manually input updates. Server 200 may be programmed to place a telephone call to the restaurant owner, employee, or manager on a predetermined or programmable schedule for updates in response, e.g., to Server 200 determining the information stale or in need of updating. The phone call may be automated. Server 200 may determine the information stale or in need of updating if it has not received new information within a predetermined or programmable time, e.g., 30 minutes. Server 200 may include rules defining the schedule in which the calls to the restaurant owner occur, e.g., Server 200 may call every 15 minutes for one hour and every hour thereafter.

Information sent by Restaurant 204 to Server 200 may include time sensitive information and non-time sensitive information. Restaurant 204 may include different user interfaces to reduce the impact of sending time sensitive information, which may be sent more often. The information sent by Restaurant 204 may include operating hours, daily specials, special events, links to reviews, typical wait times for each day of the week, up-to-the minute wait times for tables, promotions or coupons, or the like.

In this embodiment, Restaurant 204 is associated with any type of business or commercial establishment with limited capacity including restaurants, bars, theaters, movie theaters, auditoriums, golf courses, transportation services, retailers, and financial institutions.

In an embodiment, time sensitive information sent by Restaurant 204 to Server 200 may be any information that conveys to Consumer 207 the current availability of the limited capacity of the business or commercial establishment including table availability, seat availability, ticket availability, starting time availability, and special purchase availability.

FIGS. 3 and 4 show embodiments of simplified user interfaces of Restaurant 204 for sending time sensitive information to Server 200. The time sensitive information may include wait time information for a restaurant or other commercial establishment. First Restaurant Application 300 may include only three buttons—Long Wait 301 (e.g., more than 30 minutes), Short Wait 302 (e.g., less than 30 minutes), and No Wait 303 (e.g., no waiting for seating). A restaurant owner or other user, for example, may actuate the appropriate button periodically to communicate the current wait time for tables to Server 200. Second Restaurant Application 400 includes Time Selector 401 where a restaurant owner or other user may select the appropriate wait time from a list of choices. Once the restaurant owner or other user has selected the appropriate wait time, the restaurant owner or other user may actuate Send Update 402 to transmit the selected wait time to Server 200. Note too that First Restaurant Application 300 or Second Restaurant Application 400 may include the ability to specify wait times for different sizes of groups, e.g., table for 2, table for 4, or the like. Restaurant Application 300 or Second Restaurant Application 400 may also include the ability to specify wait times for different sections of a restaurant, e.g., bar, outside table for 2, main dining room table for 4, or the like.

Restaurant 204 may also contain a reminder feature that periodically prompts the restaurant owner or other user to make an update of the time sensitive information. For example, Restaurant 204 may prompt the restaurant owner or other user to update table wait time information every 15 minutes for upload to Server 200. Server 200 may determine the time sensitive information stale or in need of updating after the lapse of a predetermined time without receiving an update to the time sensitive information, e.g., after the lapse of 15 minutes from the last update.

Some information sent by Restaurant 204 to Server 200, such as promotions or coupons, may have limitations attached such as being only valid for a certain number of customers and/or for a limited time period.

Server 200 may poll Restaurant 204 to obtain time sensitive information. This polling may occur on an as needed basis, e.g., in response to a request from Consumer 207, or polling may occur periodically in response to lapse of a polling period. This polling may be SMS, email, voice mail, phone, touch-tone, push notification, or like technologies. In an embodiment, Server 200 may poll Restaurant 204 periodically by phone message. For example, Server 200 may call the restaurant owner or other user, which answers the phone and is prompted to enter the wait time in minutes on their touch-tone keypad. Server 200 may then store the wait time information for dissemination to Consumer 207. In another embodiment, Server 200 may poll the restaurant owner or other user by sending periodic SMS messages. In this embodiment, the restaurant owner or other user may reply by providing the appropriate information, e.g., wait time in minutes, using Restaurant 204. In an embodiment, the rate of polling may be predetermined or calculated dynamically. In a preferred embodiment, the polling is only performed if Restaurant 204 has not provided an update within the currently specified polling period. In a preferred embodiment, the polling period may reset whenever Restaurant 204 provides an update. If Restaurant 204 is unable to provide an update manually or by polling after lapse of the polling period, Server 200 may substitute default information. This default information may be manually entered by a user at set up or derived automatically from historical or past information. For example, Server 200 may enter 30 minutes as substitute information if the Server 200 determines that the average wait time for the past ten Fridays between a predetermined similar time, e.g., between 6:00 pm and 6:30 pm, has been 30 minutes. A person of ordinary skill in the art should recognize the many different calculations that Server 200 can make to determine substitute information using historical or other type of information.

Server 200 may additionally receive time sensitive information from a device 209 (FIG. 2B) geographically located at or near the commercial establishment. Server 200 may have different sources for the time sensitive information of the commercial establishment: 1) the restaurant owner, employee, or manager, or other user providing the information to Server 200 via Restaurant 204 or Consumer 207; 2) a user of the device 209 located at the commercial establishment via Consumer 207; or 3) a third party user whose job it is to collect time sensitive information from commercial establishments. A person of ordinary skill in the art should recognize that other sources for the time sensitive information are likely. Server 200 may blend both sources of information, e.g., average the time sensitive information reported between the restaurant owner or other user and the user of the device, before sending the time sensitive information on to Consumer 207. Server 200 may assign a higher priority or weight to the time sensitive information provided by the restaurant owner or other user. A person of ordinary skill in the art should recognize other mechanisms available to Server 200 for processing two or more distinct sources of time sensitive information. Server 200 may not accept time sensitive information from device 209 in response to device 209 not being verified to be located in the vicinity of the commercial establishment. Server 200 may verify the geographic location of device 209 using a GPS device in the device 209. Server 200 may verify the geographic location of device 209 using other mechanisms known to a person of ordinary skill in the art, e.g., wireless communication triangulation and the like.

As information is collected by Server 200, it may be modified, sorted, stored, or be otherwise prepared for eventual retrieval by Consumer 207 or Syndication Partner 202.

Consumer 207 may request information from Server 200 via the Download Link 205. Alternately, Server 200 will notify Consumer 207 when new information is available via Download Link 205. This retrieval of information may happen on an as needed or periodic basis. Consumer 207 may specify certain criteria to Server 200 to filter the information to be sent via Download Link 205 including current location, distance from current location, venue type, and price range.

Consumer 207 may further process the information retrieved via Download Link 205 before that information is made available to the user. Different forms of information display may be optimized depending on the user's device type or capability. Consumer 207 may provide information to a user with map displays, list displays, detailed information screens, pop-up messages, email, SMS, voice messages, or the like.

Consumer 207 may request Server 200 to send timely notifications of changes in status of specific commercial establishments, e.g., restaurants. Various means of filtering may be offered to allow the user to specify the types of information that may cause Restaurant 204 to send notifications, e.g., notifications regarding the wait times associated with specific restaurants. These may include favorite restaurants, those restaurants that are nearby, a number of selected nearby restaurants, or the like. The notifications may be made by various means such as by graphical map displays, list displays, detailed information screens, pop-up messages, email, SMS, voice messages, push notifications, or the like. These notifications may be made for a limited time period, including the next several hours, the rest of the evening, every weekend evening, or the like.

FIGS. 5 and 6 show simplified user interfaces of Consumer 207 for receiving time sensitive information from Server 200. First Consumer Application 500 may show nearby restaurants on a graphical Map Area 501 using Map Pins 502. Map Pins 502 may be coded by color, shape or otherwise to indicate the status of the restaurant, e.g., whether the restaurant is open or closed, whether reservations are available, or the restaurants current or expected wait times. For example, a red Map Pin 502 may indicate more than a 30 minute wait, a yellow Map Pin 502 may indicate less than 30 minute wait, a green Map Pin 502 may indicate no waiting, a white Map Pin 502 may indicate open, but no wait time available, a grey Map Pin 502 may indicate that the restaurant is closed, a dollar sign on or next to a Map Pin 502 may indicate that a coupon or promotion is available, or a clock symbol on or next to a Map Pin 502 may indicate particular events such as happy hour. Any number of graphical symbols may be used with or instead of Map Pin 502 to indicate real time situations or conditions of the commercial establishments.

Second Consumer Application 600 shows Selected Map Pin 601 that the user has actuated to get more information. Selected Map Pin 601 may cause Restaurant Info Display 602 to appear. Restaurant Info Display 602 may include the restaurant's name, cuisine, address, website, email, phone number, operating hours, daily specials, promotions or coupons, reviews, or the like.

The information stored in Server 200 may also be sent from time to time to Syndication Partner 202 via API 201. This transfer of information may be on an as needed or periodic basis as determined by Server 200 or Syndication Partner 202. Syndication Partner 202 may be websites or applications that incorporate time sensitive information into the information the websites or applications already provide. Examples of potential Syndication Partner 202 include Yelp, UrbanSpoon, Google Maps, Microsoft's Bing, and the like. Server 200 may also push time sensitive information to social networking sites like Twitter or Facebook. Server 200 may push time sensitive information on behalf of users or restaurants. For example, Server 200 may send a tweet to a restaurant user or customer every time a particular restaurant has provided updated information. For another example, Server 200 will make updates to a user's Facebook account in response to permission from the user to make such updates, in response to a request from the user for updated information, in response to a user providing updated time sensitive information to Server 200, or a combination thereof.

Once received, the information may be further processed by Syndication Partner 202. Syndication Partner 202 may integrate the information provided from Server 200 with other information available to Syndication Partner 202. For example, Yelp's restaurant reviews may be improved by the addition of time sensitive information, e.g., restaurant wait times, provided to Yelp by Server 200.

Consumer 207 may request information from Syndication Partner 202 via Alternate Download Link 206. Alternately, Syndication Partner 202 may notify Consumer 207 when new information is available via Alternate Download Link 206. This retrieval of information may happen on an as needed or periodic basis.

Consumer 207 may further process the information retrieved via Alternate Download Link 206 before that information is made available to a user.

Server 200 should include sufficient capacity and speed to handle the aggregate requirements of Restaurant 204, Consumer 207, and Syndication Partner 202. The communication links such as Upload Link 203, Download Link 205, API 201, and Alternate Download Link 206 should have sufficient capacity to handle the maximum information traffic anticipated by these links.

Server 200 and Syndication Partner 202 may not be directly accessible to most users of the system but may be indirectly accessible through Restaurant 204 and Consumer 207.

Server 200 and Syndication Partner 202 may include computer servers or groups of servers. These servers may be local, situated at a remote hosting site, or be virtual servers rented from a “cloud” server provider. Syndication Partner 202 may use time sensitive information provided by Server 200 to improve the information that Syndication Partner 202 offers to users via, e.g., a website or an application running on a mobile computing device. Server 200 may license Syndication Partner 202 on a per city, regional, or nationwide basis. A user may get time sensitive information by directly accessing Server 200 using Consumer 207 or by indirectly accessing Server 200 through Syndication Partner 202's website or application. Syndication Partner 202 access Server 200 to get updated time sensitive information as well as historical information for certain restaurants or other commercial establishments. Syndication Partner 202 may process the time sensitive information before providing it to a user, e.g., by color coding the restaurant in terms of the wait times. Syndication Partner 202 may display the time sensitive information on a list, map, or other format.

Restaurant 204 and Consumer 207 may be a variety of fixed or mobile computing devices including personal computers, tablet computers, fixed phones, and mobile phones.

The system and method described above provide the ability for Information Sources 104 to easily and quickly input time sensitive information into the Information Storage 100. The polling features of the system further reduce the burden on Information Sources 104. Additionally, Information Sinks 107 gain the ability to retrieve information from Information Sources 104 based on a variety of criteria including location, venue type, pricing, or the like.

The system and method described above may be useful for any application where there exists time sensitive information that requires some manual input to collect, and there exists multiple users who wish to see at one time a collection of that time sensitive information. In some cases, automated means may be employed to further reduce the effort required to collect the time sensitive information. These automated means may be used alone or in conjunction with manual means. The automated collection means may include interfacing with reservation systems, restaurant management software, point of sale terminals, camera based systems, sensor based systems, or the like.

While the foregoing written description of the invention enables one of ordinary skill in the art to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A system, comprising:
a memory device configured to store instructions; and
a processing device configured to execute the instructions stored in the memory device to:
receive time sensitive information for a commercial establishment; and
provide the time sensitive information to a consumer on an as needed basis in response to a request from the consumer or on a periodic basis in response to a predetermined update period.

2. The system of claim 1, wherein the commercial establishment comprises a limited capacity.

3. The system of claim 1, wherein the time sensitive information comprises a current wait time.

4. The system of claim 1, wherein the time sensitive information comprises promotions, coupons, operating hours, specials, or events.

5. The system of claim 3, wherein the time sensitive information comprises a long wait time, a short wait time, or no wait time.

6. The system of claim 1, wherein the processing device is further configured to poll the commercial establishment for the time sensitive information on an as needed basis in response to the request from the consumer or on a periodic basis in response to a polling period.

7. The system of claim 6, wherein the processing device is further configured to provide default information to the consumer in response to a lapse of the polling period during which the processing device does not receive the time sensitive information from the commercial establishment.

8. The system of claim 6, wherein the processing device is further configured to poll the commercial establishment using Short Message Service (SMS), email, voice mail, phone, push notification, or touch tone technologies.

9. The system of claim 1, wherein the processing device is further configured to poll the commercial establishment for the time sensitive information in response to a request from the consumer for updated information.

10. The system of claim 1, wherein the processing device is further configured to receive the time sensitive information for the commercial establishment from a device at the commercial establishment in response to input from a user of the device.

11. A method, comprising:
requesting a current capacity from a merchant having a limited capacity; and
providing the current capacity to a consumer on an as needed basis in response to a request from the consumer or on a periodic basis in response to a predetermined update period.

12. The method of claim 11, wherein the current capacity comprises a current wait time.

13. The method of claim 11, wherein the current capacity comprises a long wait time, a short wait time, or no wait time.

14. The method of claim 11, further comprising polling the merchant for the current capacity on as needed basis in response to the request from the consumer or on a periodic basis in response to a polling period.

15. The method of claim 14, wherein providing the current capacity to the consumer comprises providing default information to the consumer in response to a lapse of the polling period during which no current capacity is received from the merchant in response to the requesting.

16. The method of claim 14, wherein polling the merchant comprises polling the merchant using Short Message Service (SMS), email, voice mail, phone, push notification, or touch tone technologies.

17. The method of claim 14, wherein polling the merchant for the current capacity occurs in response to a request for updated information from the consumer.

18. The method of claim 11, further comprising receiving the current capacity for the merchant from a device located at the merchant in response to input from a user of the device.

19. A memory device having instructions stored thereon that, in response to execution by a processing device, causes the processing device to perform operations comprising:
requesting time sensitive information from a commercial establishment having a limited capacity; and
providing the time sensitive information to a consumer on an as needed basis in response to a request from the consumer or on a periodic basis in response to a predetermined update period.

20. The memory device of claim 19, wherein the time sensitive information comprises a current wait time.

21. The memory device of claim 19, wherein the time sensitive information comprises promotions, coupons, operating hours, specials, or events.

22. The memory device of claim 19, wherein execution of the instructions stored in the memory device by the processing device causes the processing device to perform operations further comprising polling the commercial establishment for the time sensitive information on as needed basis in response to the request from the consumer or on a periodic basis in response to a polling period.

23. The memory device of claim 22, wherein execution of the instructions stored in the memory device by the processing device causes the processing device to perform operations further comprising providing default information to the consumer in response to a lapse of the polling period during which the processing device does not receive the time sensitive information from the commercial establishment.

24. The memory device of claim 22, wherein execution of the instructions stored in the memory device by the processing device causes the processing device to perform operations further comprising polling the commercial establishment using Short Message Service (SMS), email, voice mail, phone, push notification, or touch tone technologies.

25. The memory device of claim 19, wherein execution of the instructions stored in the memory device by the processing device causes the processing device to perform operations further comprising polling the commercial establishment for the time sensitive information in response to a request from the consumer for updated information.

26. The memory device of claim 19, wherein execution of the instructions stored in the memory device by the processing device causes the processing device to perform operations further comprising receiving the time sensitive information for the commercial establishment from a device at the commercial establishment in response to input from a user of the device.
